(19) United States
(12) Patent Application Publication
(10) Pub. No.: US 2026/0307151 A1
(43) Pub. Date: Oct. 8, 2026

(54) METHODS OF POWDER LAYERING AND COMPONET MANUFACTURING

(71) Applicants: Lianyi Chen, Madison, WI (US); Ali Nabaa, Madison, WI (US); Luis Izet Escano, Madison, WI (US)

(72) Inventors: Lianyi Chen, Madison, WI (US); Ali Nabaa, Madison, WI (US); Luis Izet Escano, Madison, WI (US)

(21) Appl. No.: 19/681,528

(22) Filed: May 19, 2026

Related U.S. Application Data
(60) Provisional application No. 63/784,044, filed on Apr. 5, 2025.

(51) Int. Cl. B22F 12/50; B22F 10/14; B22F 10/28; B22F 12/40; B33Y 10/00; B33Y 30/00

(52) U.S. Cl. CPC B22F 12/50; B22F 10/14; B22F 10/28; B22F 12/40; B33Y 10/00; B33Y 30/00

(57) ABSTRACT

This disclosure explores various embodiments related to the application of powder particles for constructing powder beds and binding/sintering/fusing the layers to form a component, particularly in additive manufacturing. The methods involve utilizing a sieve-like structure with openings and a vibration inducer to facilitate the descent and settling of powder particles, forming the powder bed. Another method employs a mobile slider on the sieve system for the precise segregation of particles representing different material components. Additionally, a method involves supplying particles onto a sieve system with programmable actuated gates and controlled vibration, allowing selective blocking of sieve openings for precise layering control. These nuanced methods offer a versatile and programmable approach to powder-bed construction.

### BACKGROUND

Additive manufacturing applications encompass the incorporation of particles into a substrate, utilizing a spreader to create a uniform powdery bed. However, this process may introduce nonuniformities in powder density, consequently impacting the quality of the fabricated parts. In specific instances, a roller or blade spreader is employed to distribute the powder particles. Throughout the spreading procedure, particles tend to accumulate against the spreader, experiencing distinct stresses and motions within a defined gap that determines the spatial dimensions of the powder bed.

An illustrative scenario involves the application of metallic particles on a substrate, subsequently subjected to laser exposure in a predetermined pattern. This laser-scanned track forms a single layer, and the successive stacking of multiple layers results in the ultimate production of the printed part. Such methodologies are appealing due to their capacity to manufacture intricate parts with precision levels that conventional manufacturing techniques cannot achieve.

While conventional powder spreading techniques prove beneficial, they yield powder beds that are vulnerable to variations in spreading speed and powder irregularities. Specifically, during the formation of powder beds and under certain conditions or for particular size distributions, the spreadability of the powder is significantly compromised. Additionally, particles may aggregate, posing challenges in the deposition process and potentially resulting in a final product with non-uniform density or compositional variations. These challenges introduce considerable uncertainties in the mechanical performance of the printed parts.

Moreover, substantial challenges emerge in the construction of multi-material powder beds, given the absence of a precise and efficient method for controlling compositions at distinct locations and the quantity of deposited materials. This issue underscores the need for advancements in techniques that enable intricate control over material composition within powder beds, particularly in scenarios involving multiple materials.

### SUMMARY

Various example embodiments are directed to powder particles, their application to construct powder beds, as well as apparatuses and articles of manufacture utilizing different manufacturing processes. Such embodiments may be useful, for example, in the additive manufacturing of metallic parts. For instance, certain embodiments are directed to layering of powders for the additive manufacturing of multimaterial parts where different materials are needed at different regions within.

As may be implemented in accordance with one or more embodiments, a method is carried out as follows. Powder particles are fed into a sieve-like structure with multiple openings and incorporates a vibration inducer to improve the mobility of powder particles. Positioned away from the substrate, the system allows particles to descend and settle, forming the powder bed.

Another embodiment is directed to a method carried out as follows. The separation of particles representing different material components on the sieve system is facilitated by using a mobile slider. This slider is adjusted to precisely mark the point where the transition between materials occurs on the powder bed, with one side layering particles of one component and the opposite side accommodating particles of another component.

In another embodiment, a method involves supplying particles onto a sieve system with programmable actuated gates on all openings, followed by controlled vibration. Selective blocking of sieve openings ensures precise layering control down to the size of individual openings. This precise control allows for intentional obstruction of specific regions, facilitating the deposition of another material component within the powder bed. The high precision achieved enables the deliberate integration of diverse material components, presenting a versatile and programmable approach to the multi-material powder-bed construction process.

The foregoing discussion or summary does not aim to provide an exhaustive description of each embodiment or every implementation within the scope of the present disclosure. The subsequent presentation of figures and detailed descriptions serves to illustrate diverse embodiments.

### BRIEF DESCRIPTION OF FIGURES

A comprehensive comprehension of several exemplary embodiments may be gained by delving into the detailed description that follows, coupled with an examination of the accompanying drawings.

FIG. 1 illustrates an apparatus for a sieve system with deposited powder particles, utilizing a sieve-like structure with multiple openings and a vibration inducer for particle movement, as may be implemented with different embodiments;

FIGS. 2A-2C demonstrate a particle dispersion methodology in a sieve system, involving sequential layering of material A and material B particles with a vibration inducer influencing the deposition onto the substrate, allowing for the creation of multimaterial powder beds, and in which:

FIG. 2A depicts the layering of material A,

FIG. 2B depicts the layering of material B,

FIG. 2C depicts a mixed powder-bed upon vibrating the substrate; and

FIG. 3 shows a sieve system with a dynamic slider that segregates material components A and B, utilizing vibrations to prompt multimaterial powder particles to descend onto the substrate, as may be implemented in accordance with another example embodiment;

FIG. 4A depicts an apparatus for precise material control in powder bed production, including a sieve system with programmable actuated gates during deposition of material B particles. FIG. 4B depicts the apparatus of FIG. 4A during deposition of material A particles, including selective blocking of one or more sieve openings. FIG. 4C depicts the apparatus of FIGS. 4A-4B during deposition of an nth material layer and controlled placement of material components within the powder bed;

FIG. 5A depicts a side view of a multi-material powder bed including materials A, B, and C at different locations. FIG. 5B depicts a top view of a multi-material manufactured component having material regions corresponding to the powder bed of FIG. 5A.

Although the embodiments discussed in this context are open to modifications and alternative configurations, they have been exemplified in the drawings and will be detailed further. The intention is not to restrict the scope of the invention to the specific embodiments delineated; instead, the goal is to include all adaptations, equivalents, and alternatives within the scope of the disclosure, including elements specified in the claims. It is noteworthy that the term “example” used throughout this application serves an illustrative purpose and does not carry implicit limitations.

### DETAILED DESCRIPTION

The aspects discussed in the present disclosure pertain to a diverse range of apparatuses, systems, and methods associated with the construction of powder beds, their processing, and associated structures. Multiple methodologies within this scope entail the efficient layering of powders, eliminating the need for mechanical spreading means to establish powder beds. In specific implementations, the advantages of the present disclosure have been demonstrated, particularly in scenarios involving the layering of powders with varying size distributions or for the creation of multi-material powder beds. Although not strictly confined to these contexts, the exploration of various aspects is facilitated through instances within these exemplary scenarios.

In one or more embodiments, metallic particles are introduced into a designated sieve system and subjected to controlled vibrations to facilitate their passage through the openings of the sieve. These metallic particles exhibit polydispersity or varying sizes and may incorporate additional materials. Following the traversal of the sieve openings, gravitational forces act upon the particles, causing them to descend onto the substrate. The thickness of the powder bed can be regulated by adjusting the duration for which the sieve system covers a specific area of the substrate. This methodology offers a means to construct powder beds without reliance on mechanical spreaders. Additionally, the substrate can undergo further vibrations to optimize the arrangement and mixing of particles within the powder bed.

In the context of these methodologies, it has been established that the engagement of mechanical spreaders with particle agglomerates can impede the spreading process. Furthermore, it has been acknowledged and/or identified that stresses exerted on particles by mechanical spreaders may lead to the obliteration of powder columns at specific locations, thereby resulting in the formation of regions with reduced powder density within the powder bed. The descent of particles due to gravity and their subsequent layering ensures that minimal stresses impact the particles, thereby augmenting the uniformity of the fabricated powder bed.

The sieving operation can be executed through diverse methods of vibration. For example, vibrating the sieve might entail a singular vigorous vibrational motion aimed at disbanding powder clusters and preventing the obstruction of sieve openings. Moreover, sustained vibration of the sieve could be employed to facilitate the deposition of particles onto the substrate. As an illustration, while the sieve is undergoing vibration, it may concurrently experience translational motions at a predefined speed to guarantee the coverage of the entire substrate and to ensure the continuous layering of powder particles.

Several embodiments pertain to methodologies for producing specific apparatuses and/or articles of manufacture, as well as the apparatuses and/or articles of manufacture themselves. For example, specific embodiments are focused on the fabrication of components with variable material compositions, where heat-resistant materials are required in specific regions, while strength is emphasized in others, as observed in applications such as turbojet engines. Alternative embodiments are geared towards the incorporation of conductive materials for electric motors, structural components, and various other elements. The embodiments encompass the utilization of diverse material types and particles. Examples include but are not limited to steel, aluminum, copper, titanium, ceramics, and polymers.

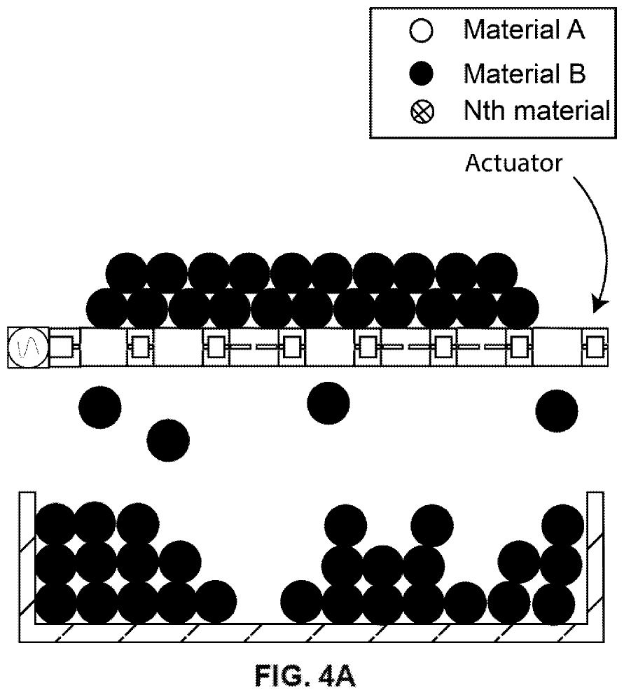

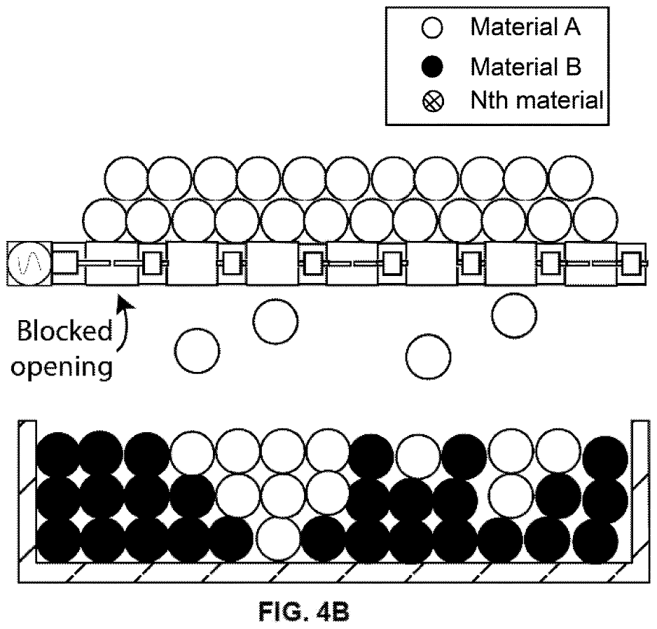

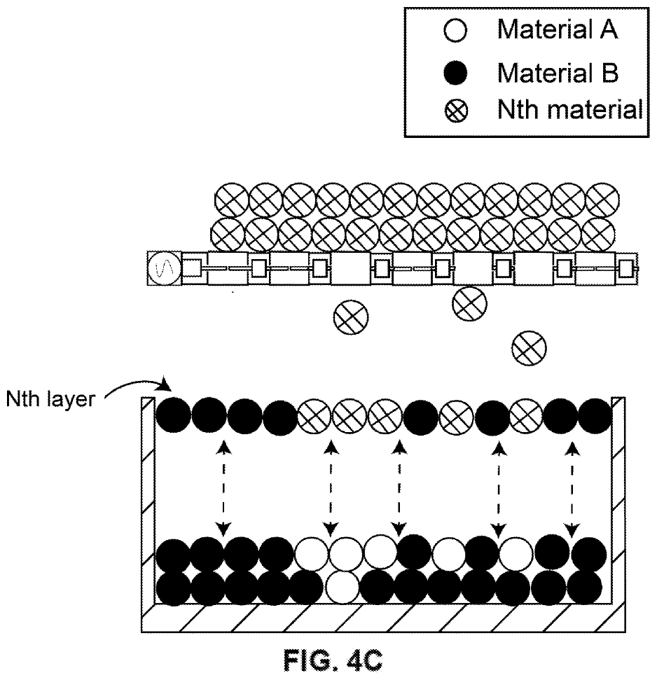

In accordance with an additional embodiment, a procedural approach unfolds as follows. Within a singular sieve system, a stratification process is implemented involving the layering of particles of material A. Concurrently, specific regions of the sieve openings are intentionally obstructed, ensuring the precise deposition of material A particles onto predetermined zones of the substrate as seen in FIG. 4A. Subsequently, another sieve is employed in conjunction with particles of material B. In this phase, the previously blocked openings are now unobstructed, facilitating the layering of material B particles onto regions that were previously inaccessible in the powder bed as depicted in FIG. 4B. This intricate sequence is undertaken with the objective of establishing a comprehensive library of materials and effecting a gradual transition in material composition across the entirety of the powder bed. This method proves particularly valuable for the creation of a diverse array of powder beds especially when numerous materials components are utilized, showcasing a multitude of compositions. Importantly, the particles utilized in this embodiment need not conform to a perfect spherical shape, contributing to the versatility and adaptability of the approach.

Across diverse applications, the segregation of particles representing distinct material components fed onto the sieve system can be achieved through the implementation of a mobile slider. This slider is manipulated to precisely demarcate the point at which the transition between materials occurs along the powder bed. On one facet of the slider, particles of one component are layered, while the opposite facet accommodates particles of another component. Within the framework of this embodiment, a guaranteed alteration in composition is accomplished along the dimensions of the powder bed, thereby enabling the controlled integration of different materials within the layered structure. This approach ensures a deliberate and controlled transformation in material composition across the specified regions of the powder bed.

Another embodiment pertains to a methodology executed in the following manner. Particles are supplied onto a sieve system equipped with openings, all of which are fitted with programmable actuated gates. Subsequently, the powder particles undergo controlled vibration, wherein numerous sieve openings are selectively blocked to ensure precise control over the layering of powder with a resolution extending down to the size of individual openings. To illustrate, specific regions of the sieve can be intentionally obstructed for a predefined duration, allowing for the deposition of another material component at these specified regions within the powder bed. This precise control can be finely tuned, facilitating the layering of a distinct material, such as material B, within a specific column of the powder bed composed primarily of material A. This level of precision enables the deliberate integration of diverse material components within the powder bed, offering a versatile and programmable approach to the powder-bed construction process.

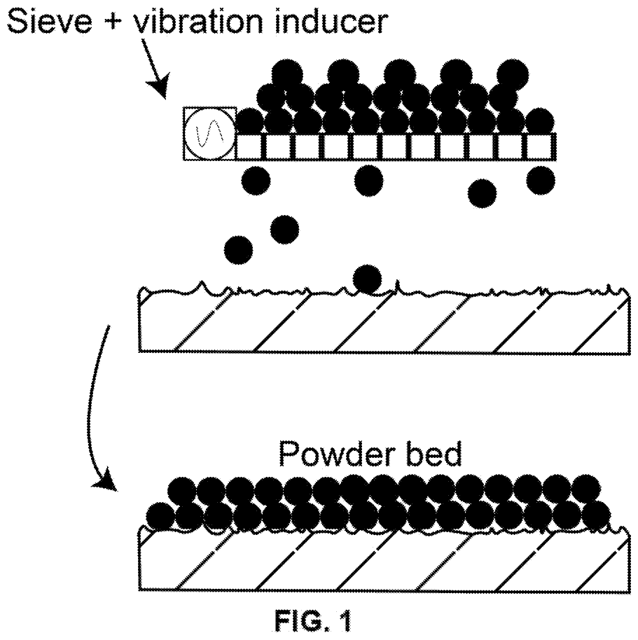

Turning now to the figures, FIG. 1 showcases an apparatus designed for the sieve system, featuring deposited powder particles, in accordance with another embodiment. The apparatus comprises a sieve-like structure with numerous openings, and the system is outfitted with a vibration inducer to enhance the movement of powder particles. Positioned at a distance from the substrate, the apparatus enables particles to descend, subsequently settling to form the powder bed. Additional embodiments encompass variations in substrates or the incorporation of motors to propel the sieve system systematically across the entire expanse of the substrate.

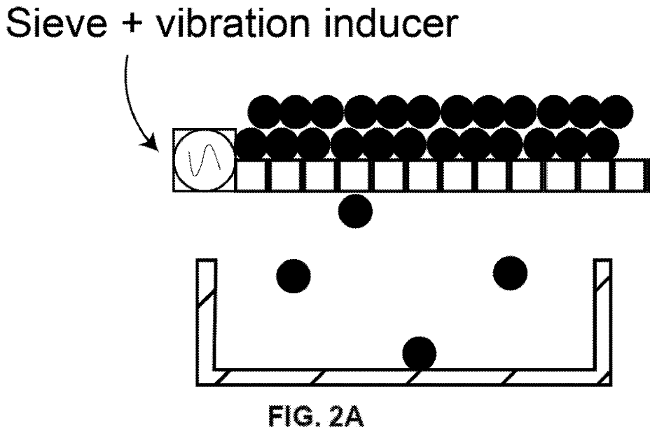

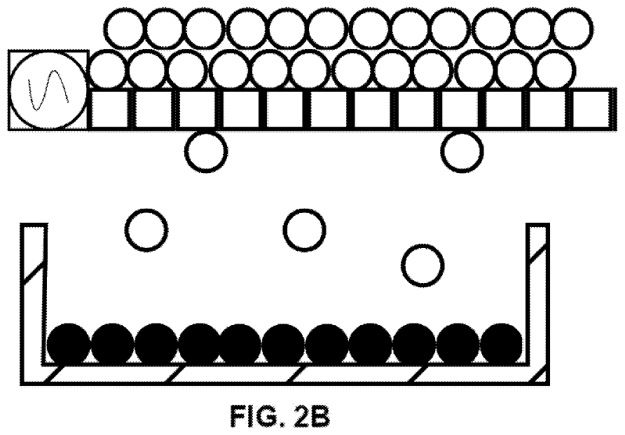

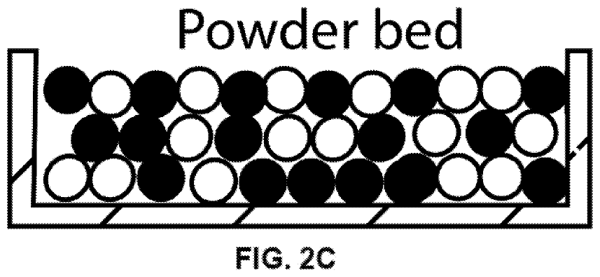

FIGS. 2A-2C provide an illustration of a methodology for particle dispersion, as can be implemented in accordance with one or more embodiments. This approach entails a sequential process within the sieve system, where the first pass involves the layering of particles of material A. The vibration inducer plays a crucial role in compelling the powder particles to descend onto the substrate. Subsequently, a second pass of the sieve system is executed to layer particles of material B, resulting in a final powder bed composed of multimaterial particles. Further enhancements to the mixing dynamics within the powder bed can be achieved by introducing vibrations to the substrate to form a powder bed as seen in FIG. 2C. It is noteworthy that a diverse array of particle types and materials may be employed to suit specific embodiments, showcasing the adaptability of the approach across various material deposition scenarios.

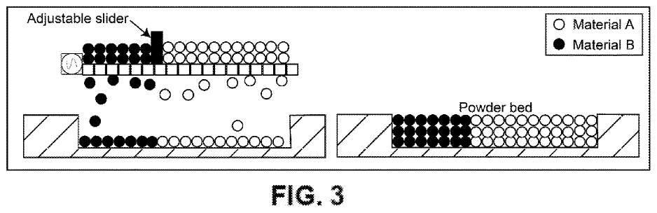

Referring to FIG. 3, the sieve system is configured with a dynamic slider designed for the segregation of two distinct material components. Material component A is situated on one side of the slider, while material component B occupies the opposite side. The implementation involves subjecting the sieve to vibrations, prompting the multimaterial powder particles to descend onto the substrate. This results in the formation of a powder bed characterized by variable materials along the longitudinal direction of the substrate. The pivotal role of the movable slider in material segregation underscores the control exercised over the composition of the powder bed. The dynamic interplay of materials along the length of the substrate exemplifies a fine approach to multimaterial deposition, with potential applications in various domains such as additive manufacturing and material engineering.

Illustrated in FIGS. 4A-4C is an apparatus designed for the precise control of material in the production of powder beds, as exemplified in another embodiment. This apparatus integrates a sieve system wherein each opening is meticulously controlled through programmable actuated gates, facilitating the layering of particles with one or more types of materials. The sieve system could incorporate a material receiver, such as a hopper or analogous structural component, designed to receive and channel powder onto the sieve system. In more advanced implementations, multiple sieve openings may be concurrently controlled to allocate specific regions of the powder bed for the deposition of one material component, while other components are directed to settle within distinct regions. This subtle control allows for the tuning of material composition in a two or three-dimensional manner, as depicted in FIG. 4C. The adaptability of this approach introduces a level of sophistication in material deposition, enabling the creation of intricate patterns and compositions within the fabricated powder bed. The precision afforded by the programmable actuated gates extends the utility of this apparatus across a spectrum of applications where tailored material compositions are paramount.

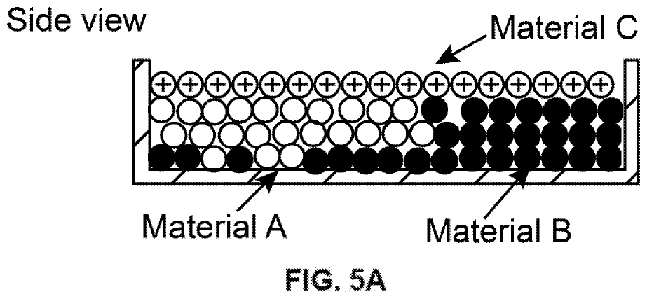

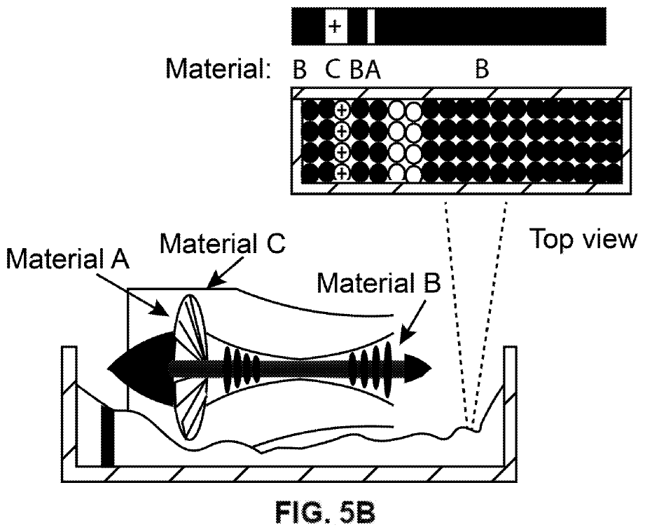

Depicted in FIGS. 5A-5B is an apparatus tailored for the application of a sieve system in the manufacturing process of multi-material systems, as illustrated in another embodiment. This apparatus intricately employs the sequential layering of three distinct material components onto the powder bed. Each pass of the sieve system is strategically designed to encompass the layering of one material component onto specific regions of the powder bed. Specifically, Material C is directed to be layered on the outermost sections of the powder bed. Concurrently, Materials A and B are deposited in a manner conducive to a second component (Material A), while the rest of the components are built using particles of Material B. A representative depiction of the powder bed is illustrated in FIG. 5A. The final constructed part is exhibited in FIG. 5B, where the material composition exhibits variations along the horizontal slice at the center of the component, as illustrated. This embodiment highlights the adaptability of the sieve system for manufacturing intricate multi-material systems and aerospace components. The deliberate control over material deposition enables the fabrication of complex geometries and varying material compositions within a single part using laser powder bed fusion, electron beam powder bed fusion, binder jetting or other additive manufacturing technologies.

Given the insights provided in the preceding discourse and accompanying illustrations, those possessing expertise in the field will readily discern that a range of modifications and alterations can be introduced to the diverse embodiments without rigidly adhering to the exemplary embodiments and applications delineated and explained herein. For instance, multiple material components may be employed, and an array of particle types, encompassing both metallic and non-metallic, can be utilized. The application of smart single-sieve opening control for the layering of particles is also feasible. These adaptations do not deviate from the authentic spirit and encompassed scope of various aspects of the invention, as outlined in the claims.

What is claimed is:

1. A method comprising:
Transferring powder to a sieve, vibrating the sieve for a designated time period, and depositing powder particles onto surfaces to form a powder layer with well controlled layer thickness.

2. The method of claim 1, wherein:
A specific sieve is vibrated, with controlled vibration frequency, amplitude and time period during the powder delivery process, ensuring precise deposition the desired amount of powder particles onto designated locations.

3. The method of claim 1, wherein:
Powder particles are deposited onto surfaces featuring diverse levels of roughness, facilitating the formation of a powder bed.

4. The method of claim 1, wherein:
The powder particles encompass materials such as metals, ceramics, and polymers.

5. The method of claim 1 comprising:
utilizing vibration and gravity to facilitate the passage of particles through sieve openings, allowing for the formation of powder layers as they descend.

6. A method involving:
Feeding of multi-material powder particles into a customizable sieve-based powder delivery system, followed by the application of vibration for a designated time period to layer multi-material powders with controlled amount onto substrates or powder beds.

7. The method of claim 6, wherein:
Each material component is introduced into a separate sieve system, undergoing multiple passes, each with varying operating times, to establish a multilayered and multi-material powder bed.

8. The method of claim 6, wherein:
The sieve delivery system incorporates a movable slider marking the transition boundary in material composition on the substrates or powder beds.

9. The method of claim 6, involves:
The use of a programmable, high-precision multimaterial powder delivery system employing a sieve with electrically actuated sieve openings configured to regulate the passage of powders with fine spatial and temporal resolutions, resulting in a powder bed characterized by precisely defined multimaterial powder distribution.

10. The method of claim 6, involves:
A delivery system enabling the layering of N different materials using a sieve system specifically calibrated for each material.

11. A method comprising:
Forming a powder layer by sieve, followed by binding/sintering/fusing the powder layer, and repeating the layering and the binding/sintering/fusing process to form a three-dimensional component.

12. The method of claim 11, involves:
Binding the powder layer by jetting binders to form a green part.

13. The method of claim 11, involves:
Sintering the powder layer by a laser, electron beam or heat to form a porous or solid part.

14. The method of claim 11, involves:
Fusing the powder layer by a laser, electron beam or heat to form a porous or solid part.
